(19) United States
(12) Patent Application Publication
(10) Pub. No.: US 2026/0223179 A1
(43) Pub. Date: Jul. 30, 2026

(54) DYNAMIC CONFIGURATION FOR RANDOM ACCESS BASED ON SLOT TYPE

(71) Applicant: QUALCOMM Incorporated, San Diego, CA (US)

(72) Inventors: Ahmed Attia ABOTABL, San Diego, CA (US); Thomas Valerrian Pasca SANTHAPPAN, San Diego, CA (US); Muhammad Sayed Khairy ABDELGHAFFAR, San Jose, CA (US)

(21) Appl. No.: 19/037,014

(22) Filed: Jan. 24, 2025

(51) Int. Cl. H04W 74/0833; H04L 5/00; H04L 5/14; H04W 72/0446; H04W 72/21

(52) U.S. Cl. CPC H04W 74/0833; H04L 5/0048; H04L 5/14; H04W 72/0446; H04W 72/21

(57) ABSTRACT

Methods, systems, and devices for wireless communications are described. In some examples, a user equipment (UE) may receive a first configuration for random access without transmitting a demodulation reference signal (DMRS) and a second configuration for random access including transmitting a DMRS. The UE may select a configuration based on occasions used to transmit a preamble and a payload of a random access message. For example, the UE may select the first configuration if the occasions have a same slot type (e.g., half-duplex slot, subband full duplex slot) or may select the second configuration if the occasions have different slot types. In some cases, the UE may select the preamble from a first set of preambles associated with the first configuration or from a second set of preambles associated with the second configuration. Additionally, or alternatively, the UE may select the first configuration based on a time window.

### FIELD OF TECHNOLOGY

The following relates to wireless communications, including dynamic configuration for random access based on slot type.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an indication of a first random access configuration and an indication of second random access configuration, where the first random access configuration is associated with channel estimation based on one or more random access preambles, and where the second random access configuration is associated with channel estimation based on one or more demodulation reference signals (DMRSs), selecting, from among the first random access configuration and the second random access configuration, a random access configuration for transmission of a random access message, where selection of the random access configuration is based on a slot type associated with a random access channel (RACH) occasion (RO) and a slot type associated with a physical uplink shared channel (PUSCH) occasion (PO), and transmitting, in accordance with the selected random access configuration, a preamble of the random access message via the RO and a payload of the random access message via the PO.

A UE for wireless communications is described. The UE may include one or more memories storing processor executable code, a transceiver, and one or more processors coupled with the one or more memories and the transceiver. The one or more processors may individually or collectively be configured to (e.g., operable to execute the code to) cause the UE to receive, via the transceiver, an indication of a first random access configuration and an indication of second random access configuration, where the first random access configuration is associated with channel estimation based on one or more random access preambles, and where the second random access configuration is associated with channel estimation based on one or more DMRSs, select, from among the first random access configuration and the second random access configuration, a random access configuration for transmission of a random access message, where selection of the random access configuration is based on a slot type associated with a RO and a slot type associated with an PO, and transmit, via the transceiver and in accordance with the selected random access configuration, a preamble of the random access message via the RO and a payload of the random access message via the PO.

Another UE for wireless communications is described. The UE may include means for receiving an indication of a first random access configuration and an indication of second random access configuration, where the first random access configuration is associated with channel estimation based on one or more random access preambles, and where the second random access configuration is associated with channel estimation based on one or more DMRSs, means for selecting, from among the first random access configuration and the second random access configuration, a random access configuration for transmission of a random access message, where selection of the random access configuration is based on a slot type associated with a RO and a slot type associated with an PO, and means for transmitting, in accordance with the selected random access configuration, a preamble of the random access message via the RO and a payload of the random access message via the PO.

A non-transitory computer-readable medium storing code for wireless communications is described. The code may include instructions executable by one or more processors to receive an indication of a first random access configuration and an indication of second random access configuration, where the first random access configuration is associated with channel estimation based on one or more random access preambles, and where the second random access configuration is associated with channel estimation based on one or more DMRSs, select, from among the first random access configuration and the second random access configuration, a random access configuration for transmission of a random access message, where selection of the random access configuration is based on a slot type associated with a RO and a slot type associated with an PO, and transmit, in accordance with the selected random access configuration, a preamble of the random access message via the RO and a payload of the random access message via the PO.

In some examples of the method, user equipment (UEs), and non-transitory computer-readable medium described herein, operations, features, means, or instructions for selecting the random access configuration for transmitting the random access message may include operations, features, means, or instructions for selecting the first random access configuration based on the slot type associated with the RO being a same slot type as the slot type associated with the PO.

In some examples of the method, user equipment (UEs), and non-transitory computer-readable medium described herein, the slot type associated with the RO being the same slot type as the slot type associated with the PO may include the RO and the PO both being associated with an uplink (UL) half-duplex (HD) slot type; or the RO and the PO both being associated with a subband full-duplex (SBFD) slot type.

In some examples of the method, user equipment (UEs), and non-transitory computer-readable medium described herein, operations, features, means, or instructions for selecting the random access configuration for transmitting the random access message may include operations, features, means, or instructions for selecting the second random access configuration based on the slot type associated with the RO being different than the slot type associated with the PO.

In some examples of the method, user equipment (UEs), and non-transitory computer-readable medium described herein, the slot type associated with the RO being different than the slot type associated with the PO may include the RO being associated with a UL slot type and the PO being associated with a SBFD slot type; or the RO being associated with the SBFD slot type and the PO being associated with the UL slot type.

Some examples of the method, user equipment (UEs), and non-transitory computer-readable medium described herein may further include operations, features, means, or instructions for refraining from transmitting a DMRS via the PO in accordance with the selected random access configuration being the first random access configuration, where the preamble of the random access message supports channel estimation for the PO and decoding of the payload of the random access message.

Some examples of the method, user equipment (UEs), and non-transitory computer-readable medium described herein may further include operations, features, means, or instructions for transmitting a DMRS via the first PO in accordance with the selected random access configuration being the second random access configuration where the DMRS supports channel estimation for the PO and decoding of the payload of the random access message.

Some examples of the method, user equipment (UEs), and non-transitory computer-readable medium described herein may further include operations, features, means, or instructions for selecting, from among the first random access configuration and the second random access configuration, another random access configuration for transmission of a second random access message, where the other random access configuration for transmission of the second random access message may be different than the selected random access configuration for transmission of the random access message, and where selection of the other random access configuration may be based on a slot type associated with a second RO and a slot type associated with a second PO and transmitting, in accordance with the other random access configuration, a preamble of the second random access message via the second RO and a payload of the second random access message via the PO.

In some examples of the method, user equipment (UEs), and non-transitory computer-readable medium described herein, the first random access configuration may be associated with a first set of random access preambles and the second random access configuration may be associated with a second set of random access preambles, and the method, apparatuses, and non-transitory computer-readable medium may include further operations, features, means, or instructions for selecting a preamble for the random access message, where whether the selected preamble is selected from the first set of random access preambles or from the second set of random access preambles may be based on the slot type associated with the RO and the slot type associated with the PO, a RSRP threshold, a retransmission counter, or any combination thereof.

In some examples of the method, user equipment (UEs), and non-transitory computer-readable medium described herein, selection of the random access configuration may be further based on whether a separation in time between the RO and the PO satisfies a threshold duration.

In some examples of the method, user equipment (UEs), and non-transitory computer-readable medium described herein, the first random access configuration, the second random access configuration, or both include an indication of the threshold duration; the first random access configuration may be eligible for selection when the separation in time between the RO and the PO may be less than the threshold duration; and the first random access configuration may be ineligible for selection when the separation in time between the RO and the PO may be greater than the threshold duration.

In some examples of the method, user equipment (UEs), and non-transitory computer-readable medium described herein, the slot type associated with the RO may be a HD slot type or a SBFD slot type and the slot type associated with the PO may be the HD slot type or the SBFD slot type.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports dynamic configuration for random access based on slot type in accordance with one or more aspects of the present disclosure.

FIG. 2 shows an example of a wireless communications system that supports dynamic configuration for random access based on slot type in accordance with one or more aspects of the present disclosure.

FIG. 3 shows an example of a slot configuration diagram that supports dynamic configuration for random access based on slot type in accordance with one or more aspects of the present disclosure.

FIG. 4 shows an example of a process flow that supports dynamic configuration for random access based on slot type in accordance with one or more aspects of the present disclosure.

FIGS. 5 and 6 show block diagrams of devices that support dynamic configuration for random access based on slot type in accordance with one or more aspects of the present disclosure.

FIG. 7 shows a block diagram of a communications manager that supports dynamic configuration for random access based on slot type in accordance with one or more aspects of the present disclosure.

FIG. 8 shows a diagram of a system including a device that supports dynamic configuration for random access based on slot type in accordance with one or more aspects of the present disclosure.

FIG. 9 shows a flowchart illustrating methods that support dynamic configuration for random access based on slot type in accordance with one or more aspects of the present disclosure.

### DETAILED DESCRIPTION

In some wireless communications systems, wireless devices may implement random access procedures to establish communications with other wireless devices. For example, a user equipment (UE) may perform a random access procedure with a network entity. In some cases, the UE may perform a two-step random access procedure, where the UE transmits a first random access channel (RACH) message (e.g., RACH MsgA). The RACH message may include a physical RACH (PRACH) preamble transmitted in a first occasion (e.g., a RACH occasion (RO)) and a payload (e.g., a physical uplink shared channel (PUSCH)) transmitted in a second occasion (e.g., a PUSCH occasion (PO)). In some examples, the UE may be configured for demodulation reference signal (DMRS)-less RACH, where the UE refrains from transmitting DMRS via the PO. In such examples, the network entity may use the PRACH (e.g., the RO) for channel estimation (e.g., instead of a DMRS).

If, however, the RO is in a first type of slot and the corresponding PO is in a second type of slot, the network entity may not be able to use the RO for channel estimation. For example, if the RO is in a half-duplex (HD) slot and the PO is in a subband full-duplex (SBFD) slot, the network entity may be unable to use channel estimation from the RO due to self-interference in the SBFD slot. In another example, if the RO is in a SBFD slot and the PO is in a HD slot, the bandwidth of the PO may not be contained within the bandwidth of the corresponding RO used for channel estimation.

Various aspects of the present solution are related to dynamic configuration for random access based on slot type, such as a UE selecting between DMRS-based and DMRS-less RACH based on whether the RO for a RACH preamble portion of MsgA and the PO for the corresponding PUSCH portion of the MsgA are in the same type of slot (e.g., the same slot, or different slots of a same type) or are in different types of slots. In some examples, a UE may receive a first configuration associated with DMRS-less RACH and a second configuration associated with DMRS-based RACH. The UE may select a random access mode based on a slot type of a first RO and a first PO for communicating a random access message. For example, the UE may select a first random access mode associated with the first configuration (e.g., with DMRS-less RACH) if a slot that includes the first RO is the same type (e.g., HD, SBFD) as a slot that includes the first PO. In another example, the UE may select a second random access mode associated with the second configuration (e.g., with DMRS-based RACH) if the slot that includes the first RO is a different type as the slot that includes the first PO. In some cases, the UE may select preambles for transmitting the random access messages from a first set of preambles associated with the first configuration or from a second set of preambles associated with the second configuration. Additionally, or alternatively, the UE may be configured with a time window for selecting the first configuration (e.g., for DMRS-less RACH).

Aspects of the disclosure are initially described in the context of wireless communications systems. Aspects of the disclosure are additionally described with reference to slot configuration diagrams and process flows. Aspects of the disclosure are further illustrated by and described with reference to apparatus diagrams, system diagrams, and flowcharts that relate to dynamic configuration for random access based on slot type. Although examples are described herein with respect to slots and slot types, it is to be understood that the teachings herein may be applied to other transmission time intervals and types thereof.

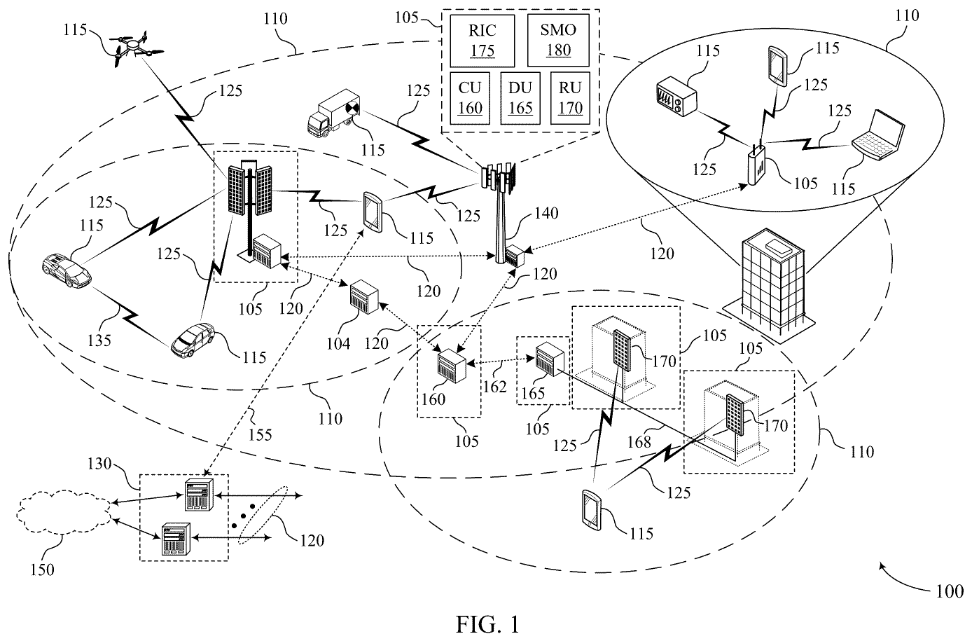

FIG. 1 shows an example of a wireless communications system 100 that supports dynamic configuration for random access based on slot type in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support dynamic configuration for random access based on slot type as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink (DL) component carriers and one or more uplink (UL) component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a DL carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include DL transmissions, UL transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 may receive both a first configuration for performing RACH without transmitting DMRS (e.g., DMRS-less RACH) and a second configuration for performing RACH with DMRS (e.g., DMRS-based RACH). The UE 115 may select between the first configuration and the second configuration based on a slot type of a first RO and a first PO for communicating a random access message. For example, the UE 115 may select the first configuration (e.g., the DMRS-less RACH configuration) if a slot that includes the first RO is the same slot type as a slot that includes the first PO. In another example, the UE 115 may select the second configuration (e.g., the DMRS-based RACH configuration) if the slot that includes the first RO is a different slot type as the slot that includes the first PO. In some cases, the UE 115 may select preambles for transmitting the random access messages from a first set of preambles associated with the first configuration or from a second set of preambles associated with the second configuration. Additionally, or alternatively, the UE 115 may be configured with a time window (e.g., a threshold duration) for selecting and applying the DMRS-less RACH configuration. Any POs within the time window may be DMRS-less POs, and any POs that fall outside of the time window may be DMRS-based POs.

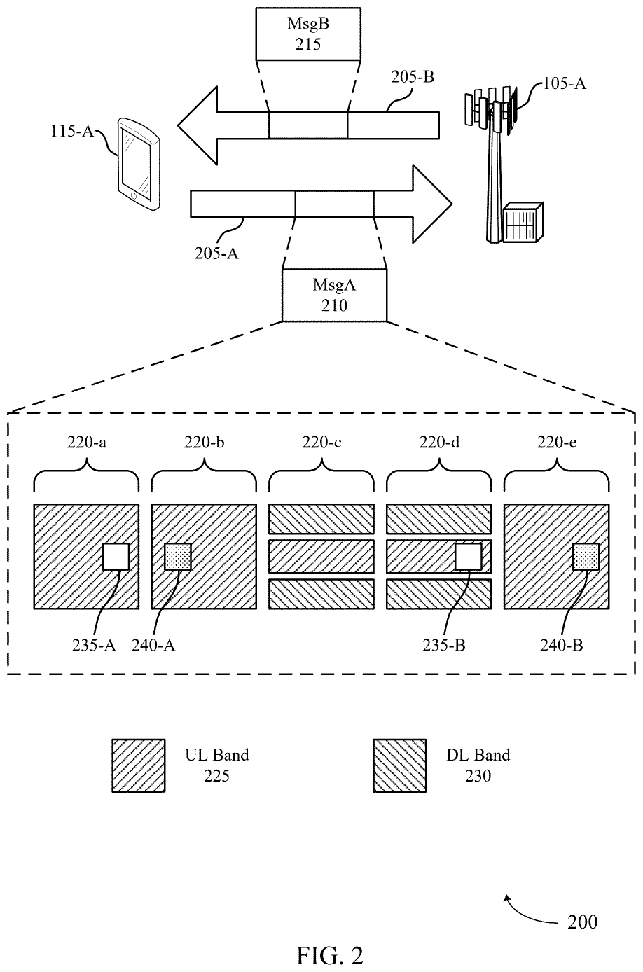

FIG. 2 shows an example of a wireless communications system 200 that supports dynamic configuration for random access based on slot type in accordance with one or more aspects of the present disclosure. The wireless communications system 200 may include a UE 115-a in communications with a network entity 105-a, which may be examples of corresponding devices described herein, including with reference to FIG. 1. The UE 115-a and the network entity 105-a may communicate via communication links 205 (e.g., communication link 205-a, communication link 205-b), which may be an example of UL communications, DL communications, or both. For example, communications between the UE 115-a and the network entity 105-a via the communication link 205-a as depicted in the example of FIG. 2 may include UL communications, and communications between the UE 115-a and the network entity 105-a via the communication link 205-b as depicted in the example of FIG. 2 may include DL communications.

To establish communications with the network entity 105-a, the UE 115-a may perform an access procedure (e.g., a RACH procedure). Such a RACH procedure may include communicating messages with the network entity 105-a to establish a wireless channel for communications. In the example of FIG. 2, the UE 115-a and the network entity 105-a may implement or otherwise support a 2-step RACH procedure, which may reduce signaling between devices relative to a conventional 4-step RACH procedure. For example, the 2-step RACH procedure illustrated in FIG. 2 may include the transmission of a RACH MsgA 210 (e.g., a first RACH message) by the UE 115-a. In response to the MsgA 210, the UE 115-a may receive a RACH MsgB 215 (e.g., a second RACH message) from the network entity 105-a.

The UE 115-a may perform the RACH procedure (e.g., communicate RACH messages) over one or more slots. In some examples, The UE 115-a may be configured with multiple slot types, including HD slots and full-duplex (FD) slots, such as SBFD slots. In the example of FIG. 2, the UE may be configured with a first slot 220-a, a second slot 220-b, a third slot 220-c, a fourth slot 220-d, and a fifth slot 220-e. The first slot 220-a, the second slot 220-b, and the fifth slot 220-e may be examples of HD slots, whereas the third slot 220-c and the fourth slot 220-d may be examples of SBFD slots. HD slots may be associated with one direction of travel (e.g., UL or DL). In some examples, the first slot 220-a, the second slot 220-b, and the fifth slot 220-e may be associated with UL communications. For example, the first slot 220-a, the second slot 220-b, and the fifth slot 220-e may include a UL band 225. Conversely, SBFD slots may be associated with multiple directions of travel (e.g., UL and DL). In some examples, the third slot 220-c and the fourth slot 220-d may be associated with both the UL band 225 and the DL band 230. For example, the third slot 220-c and the fourth slot 220-d may include one or more UL bands 225 and one or more DL bands 230.

The MsgA 210 may include both a PRACH preamble and a PUSCH, which are sent in separate messages in a 4-step RACH procedure (e.g., a RACH Msg1 and a RACH Msg3). The UE 115-a may be configured with multiple occasions for transmitting the preamble and the PUSCH for the MsgA 210. For example, the UE 115-a may transmit a preamble of a MsgA 210 via a RO 235. Similarly, the UE 115-a may transmit a PUSCH of a MsgA 210 via a PO 240. Each RO 235 and PO 240 may be associated with (e.g., transmitted via) a type of slot 220. For example, the UE 115-a may transmit a first preamble of a first MsgA 210 via a first RO 235-a included in the first slot 220-a (e.g., a HD slot, a UL slot). The UE 115-a may transmit a second preamble of a second MsgA 210 via a second RO 235-b included in the fourth slot 220-d (e.g., a SBFD slot). Similarly, the UE 115-a may transmit a first PUSCH of the first MsgA 210 via a first PO 240-a included in the second slot 220-b (e.g., a HD slot, a UL slot). The UE 115-a may transmit a second PUSCH of the second MsgA 210 via a second PO 240-b included in the fifth slot 220-e (e.g., a HD slot, a UL slot). In some examples, each RO 235 may be associated with a PO 240 or a set of POs 240. For example, the first RO 235-a may map to the first PO 240-a based on the preamble transmitted via the first RO 235-a.

In some examples, the UE 115-a may transmit a reference signal (e.g., a DMRS during a PO 240. The network entity 105-a may receive and measure the DMRS to perform channel estimation and receive PUSCH of a MsgA 210 transmitted during the PO 240. RACH procedures that implement DMRS for channel estimation may be examples of DMRS-based RACH. In some other examples, the UE 115-a may refrain from transmitting DMRS during the PO 240. Instead, in such examples, the network entity 105-a may use a preamble of the MsgA 210 (e.g., received during a corresponding RO 235) to perform channel estimation and receive the PUSCH of the MsgA 210. RACH procedures that do not transmit DMRS for channel estimation may be examples of DMRS-less RACH. The UE 115-a may use the preamble (e.g., PRACH preamble) for channel estimation in cases where the bandwidth associated with the PUSCH is contained within (e.g., fits within, is less than) the bandwidth associated with the RO 235 that includes the preamble.

In an example, in a TDD system, if the RO 235 and the PO 240 associated with transmission of a MsgA 210 are included in a same slot, the UE 115-a may implement DMRS-less RACH (e.g., DMRS-less PUSCH transmission). However, there may be some cases where the UE 115-a cannot support or otherwise implement DMRS-less RACH. For example, in a SBFD system, if the RO 235 and the PO 240 associated with transmission of a MsgA 210 are in different slots (e.g., different SBFD slots), the UE 115-a may be unable to use the RO 235 for channel estimation for the corresponding PO 240 due to self-interference experienced by the SBFD slot. In another example, in a SBFD system, if the RO 235 is included in an UL band 225 of a SBFD slot and the PO 240 is included in a HD slot (e.g., a UL slot), the UE 115-a may be unable to use the RO 235 for channel estimation due to the bandwidth associated with the PUSCH being uncontained in the bandwidth associated with the RO 235. To resolve this, the UE 115-a may implement techniques for dynamic random access based on slot type as described herein.

Various aspects of the present disclosure are related to dynamic random access based on slot type. In some examples, the UE 115-a may support switching between a first configuration (e.g., a random access configuration) for DMRS-less RACH and a second configuration for DMRS-based RACH. The DMRS-less RACH configuration may include one or more DMRS-less POs 240. Similarly, the DMRS-based RACH configuration may include one or more DMRS-based POs 240. The network entity 105-a may configure the UE 115-a with both the DMRS-less RACH configuration and the DMRS-based RACH configuration (e.g., via control signaling). The UE 115-a may select either the DMRS-less RACH configuration or the DMRS-based RACH configuration for performing a RACH procedure (e.g., for communicating one or more RACH messages) based on the slot type associated with an RO 235 and a PO 240 associated with transmitting a MsgA 210 of a RACH procedure.

For example, the UE 115-a may initially choose the DMRS-less RACH configuration for performing RACH. However, the UE 115-a may fall back from the DMRS-less RACH configuration to the DMRS-based RACH configuration for transmitting a given MsgA if the corresponding RO 235 and PO 240 are associated with different slot types. Similarly, the UE 115-a may initially choose the DMRS-based RACH configuration, but may fall back to the DMRS-less RACH configuration if the corresponding RO 235 and PO 240 are associated with a same slot type.

In the example of FIG. 2, the UE 115-a may transmit a first preamble in the first RO 235-a, which may be associated with a HD slot type (e.g., UL slot type) based on the first RO 235-a being included in the first slot 220-a. The UE 115-a may transmit a first PUSCH in the first PO 240-a, which also may be associated with the HD slot type (e.g., UL slot type) based on the first PO 240-a being included in the second slot 220-b. Because the first RO 235-a and the first PO 240-a are associated with the same slot type (e.g., an HD slot, a UL slot), the UE 115-a may select the DMRS-less RACH configuration and transmit the first PUSCH via the first PO 240-a without also transmitting DMRS in the first PO 240-a (e.g., a DMRS-less PO 240).

Similarly, in the example of FIG. 2, the UE 115-a may transmit a second preamble in the second RO 235-b, which may be associated with a SBFD slot type based on the second RO 235-b being included in the fourth slot 220-d. The UE 115-a may transmit a second PUSCH in the second PO 240-b, which also may be associated with the HD slot type (e.g., UL slot type) based on the second PO 240-b being included in the fifth slot 220-e. Because the second RO 235-b and the second PO 240-b are associated with different slot types (e.g., a SBFD slot and a HD slot), the UE 115-a may select the DMRS-based RACH configuration and transmit the second PUSCH via the second PO 240-b while also transmitting DMRS in the second PO 240-b (e.g., a DMRS-based PO 240).

In some examples, the network entity 105-a may configure the UE 115-a with multiple sets of preambles. For example, an RO 235 may include multiple sets of preambles, including a first set of preambles reserved for (e.g., associated with) DMRS-less RACH and a second set of preambles reserved for DMRS-based RACH. The first set of preambles (e.g., DMRS-less preambles) may map to a set of DMRS-less POs 240, and the second set of preambles (e.g., DMRS-based preambles) may map to a set of DMRS-based POs 240. The UE 115-a may select between the first set of preambles or the second set of preambles based on one or multiple criteria, including the slot type of the RO 235 and the PO 240 (e.g., based on the selected RACH configuration), a reference signal received power (RSRP) threshold value, a retransmission counter (e.g., associated with the MsgA 210), or any combination thereof.

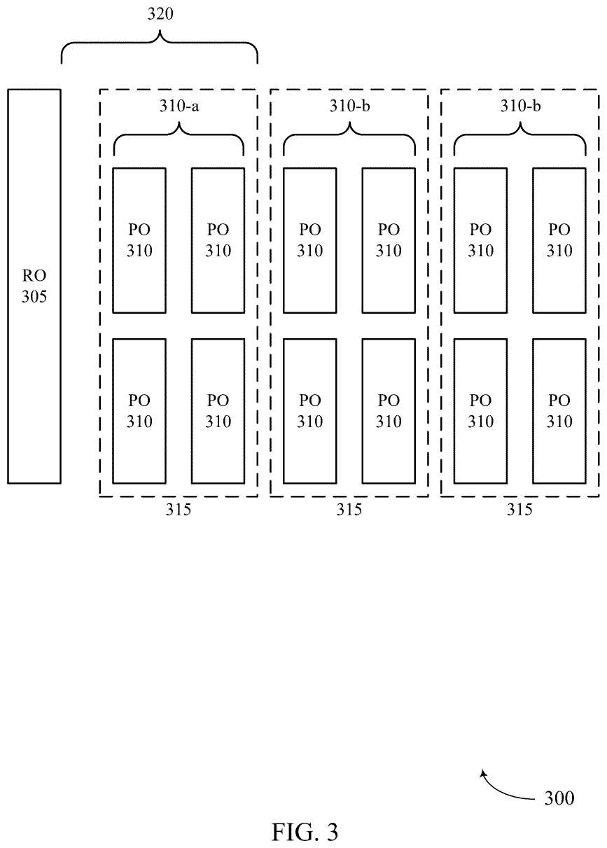

FIG. 3 shows an example of a slot configuration diagram 300 that supports dynamic configuration for random access based on slot type in accordance with one or more aspects of the present disclosure. The slot configuration diagram 300 may illustrate an example slot configuration implemented by a UE (not shown) for performing RACH with a network entity (not shown) in accordance with the techniques described herein. The UE and the network entity may be examples of corresponding devices described herein, including with reference to FIGS. 1 and 2. As described with reference to FIG. 2, the UE may switch between a first configuration for DMRS-less RACH and a second configuration for DMRS-based RACH.

The UE may transmit a preamble of a RACH MsgA via a RO 305 and may transmit PUSCH in one or more POs 310, which may span one or multiple slots 315. The RO 305 may map to the POs 310. In some examples where the UE is configured for DMRS-less RACH (e.g., for DMRS-less PUSCH transmission), the network entity may configure a time window 320 (e.g., duration) associated with DMRS-less RACH (e.g., with a DMRS-less RACH configuration). The time window may be after each RO 305 (e.g., may start after each RO 305) and may determine a set of DMRS-less POs 310-a. Any POs 310 that fall outside of the time window 320 may be DMRS-based POs 310-b, and the UE may transmit DMRS alongside PUSCH transmitted via the DMRS-based POs 310-b.

For example, in FIG. 3, the UE may initially select the DMRS-less RACH configuration. The UE may be capable of selecting the DMRS-less RACH configuration for transmitting PUSCH if the PO 310 is within the time window 320. That is, as long as a separation (e.g., in time) between the RO 305 and the PO 310 is within the time window 320 (e.g., is less than a threshold duration), the UE may select the DMRS-less RACH configuration and may transmit PUSCH in one or all of the set of DMRS-less POs 310-a. However, if the separation between the RO 305 and the PO 310 is outside of the time window (e.g., is greater than the threshold duration), the UE may select the DMRS-based RACH configuration and may transmit PUSCH in one or all of the DMRS-based POs 310-b (e.g., with DMRS).

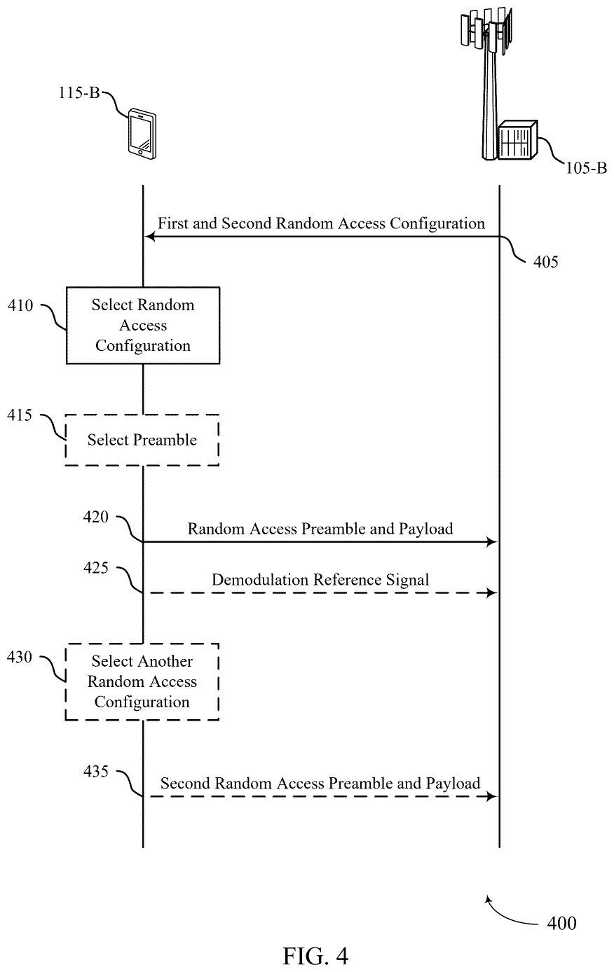

FIG. 4 shows an example of a process flow 400 that supports dynamic configuration for random access based on slot type in accordance with one or more aspects of the present disclosure. The process flow 400 may implement or be implemented by aspects of the wireless communications system 100, the wireless communications system 200, and the slot configuration diagram 300 as described herein with reference to FIGS. 1, 2, and 3. For example, the process flow 400 may illustrate actions performed by a UE 115-b and a network entity 105-b, which may be examples of corresponding devices described herein, including with reference to FIGS. 1, 2, and 3. In the following description of the process flow 400, the operations between the UE 115-b and the network entity 105-b may be performed in a different order than the example shown, or the operations between the UE 115-b and the network entity 105-b may be performed in different orders at different times. Some operations may also be omitted from the process flow 400, and other operations may be added to the process flow 400.

At 405, the UE 115-b may receive an indication of a first random access configuration and an indication of second random access configuration. In some examples, the first random access configuration may be associated with channel estimation based on one or more random access preambles, and the second random access configuration may be associated with channel estimation based on one or more DMRS.

At 410, the UE 115-b may select, from among the first random access configuration and the second random access configuration, a random access configuration for transmission of a random access message. In some examples, the selection of the random access configuration may be based on a slot type associated with a RO and a slot type associated with a PO. The slot type associated with the RO may be a HD slot type or a SBFD slot type, and the slot type associated with the PO may be the HD slot type or the SBFD slot type.

In some examples, to select the random access configuration, the UE 115-b may select the first random access configuration based on the slot type associated with the RO being a same slot type as the slot type associated with the PO. For example, the slot type associated with the RO being the same slot type as the slot type associated with the PO may include the RO and the PO both being associated with a UL HD slot type or the RO and the PO both being associated with the SBFD slot type.

In some other examples, to select the random access configuration, the UE 115-b may select the second random access configuration based on the slot type associated with the RO being different than the slot type associated with the PO. For example, the slot type associated with the RO being different than the slot type associated with the PO may include the RO being associated with the UL slot type and the PO being associated with the SBFD slot type or the RO being associated with the SBFD slot type and the PO being associated with the UL slot type.

Additionally, or alternatively, selection of the random access configuration may be further based on whether a separation in time between the RO and the PO satisfies a threshold duration. In such cases, the first random access configuration, the second random access configuration, or both may include an indication of the threshold duration. The first random access configuration may be eligible for selection when the separation in time between the RO and the PO is less than the threshold duration. Conversely, the first random access configuration may be ineligible for selection when the separation in time between the RO and the PO is greater than the threshold duration.

In some examples, the first random access configuration may be associated with a first set of random access preambles and the second random access configuration may be associated with a second set of random access preambles. In such examples, at 415, the UE 115-b may select a preamble for the random access message. Whether the selected preamble is selected from the first set of random access preambles or selected from the second set of random access preambles may be based on the slot type associated with the RO and the slot type associated with the PO, a RSRP threshold, a retransmission counter, or any combination thereof.

At 420, the UE 115-b may transmit, in accordance with the selected random access configuration, a preamble of the random access message via the RO and a payload of the random access message via the PO. In some cases, the UE 115-b may transmit the preamble selected in 415.

In some examples, at 425, the UE 115-b may transmit a DMRS via the first PO in accordance with the selected random access configuration being the second random access configuration. In such cases, the DMRS may support channel estimation for the PO and decoding of the payload of the random access message. Alternatively, in some examples the UE 115-b may refrain from transmitting the DMRS via the PO in accordance with the selected random access configuration being the first random access configuration. In such cases, the preamble of the random access message may support channel estimation for the PO and decoding of the payload of the random access message.

At 430, the UE 115-b may select, from among the first random access configuration and the second random access configuration, another random access configuration for transmission of a second random access message. In some examples, the other random access configuration for transmission of the second random access message may be different than the selected random access configuration for transmission of the random access message. Additionally, or alternatively, selection of the other random access configuration may be based on a slot type associated with a second RO and a slot type associated with a second PO.

At 435, the UE 115-b may transmit, in accordance with the other random access configuration, a preamble of the second random access message via the second RO and a payload of the second random access message via the PO.

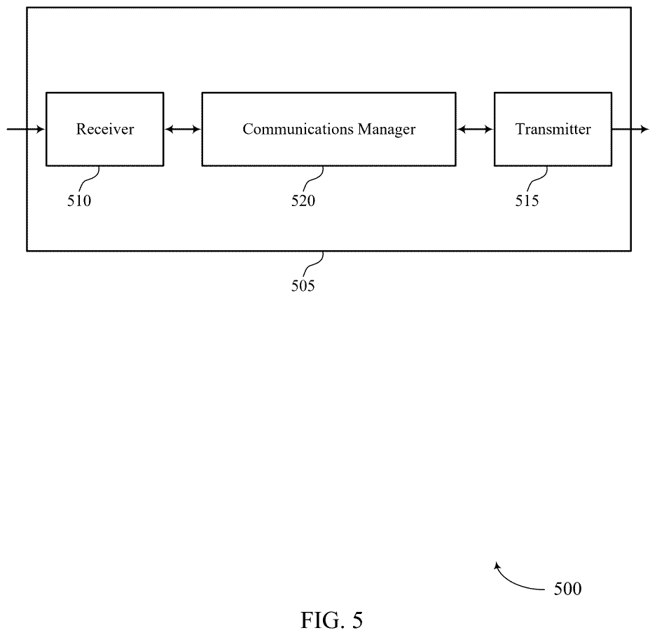

FIG. 5 shows a block diagram 500 of a device 505 that supports dynamic configuration for random access based on slot type in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to dynamic configuration for random access based on slot type). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to dynamic configuration for random access based on slot type). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of dynamic configuration for random access based on slot type as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving an indication of a first random access configuration and an indication of second random access configuration, where the first random access configuration is associated with channel estimation based on one or more random access preambles, and where the second random access configuration is associated with channel estimation based on one or more DMRSs. The communications manager 520 is capable of, configured to, or operable to support a means for selecting, from among the first random access configuration and the second random access configuration, a random access configuration for transmission of a random access message, where selection of the random access configuration is based on a slot type associated with a RO and a slot type associated with an PO. The communications manager 520 is capable of, configured to, or operable to support a means for transmitting, in accordance with the selected random access configuration, a preamble of the random access message via the RO and a payload of the random access message via the PO.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

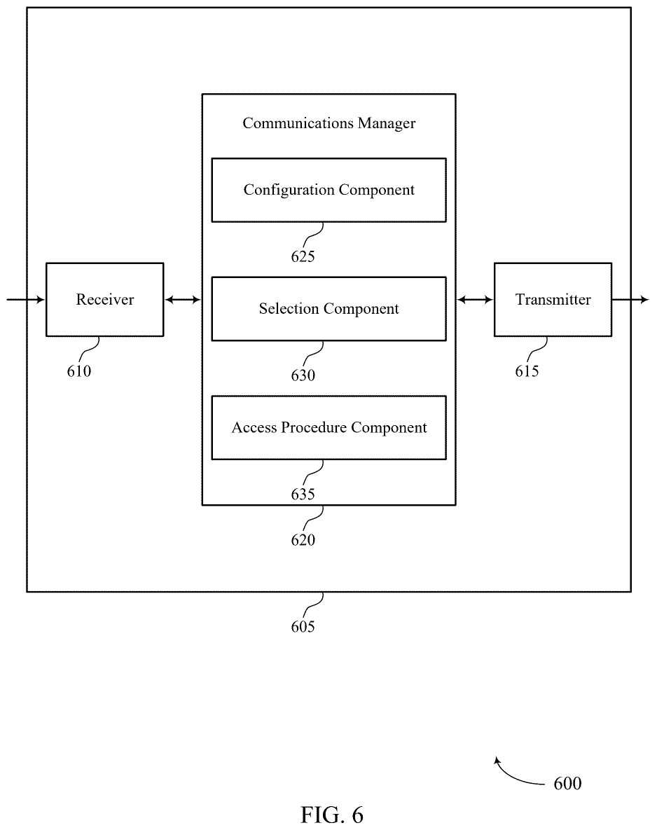

FIG. 6 shows a block diagram 600 of a device 605 that supports dynamic configuration for random access based on slot type in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to dynamic configuration for random access based on slot type). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to dynamic configuration for random access based on slot type). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of dynamic configuration for random access based on slot type as described herein. For example, the communications manager 620 may include a configuration component 625, a selection component 630, an access procedure component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for receiving an indication of a first random access configuration and an indication of second random access configuration, where the first random access configuration is associated with channel estimation based on one or more random access preambles, and where the second random access configuration is associated with channel estimation based on one or more DMRSs. The selection component 630 is capable of, configured to, or operable to support a means for selecting, from among the first random access configuration and the second random access configuration, a random access configuration for transmission of a random access message, where selection of the random access configuration is based on a slot type associated with a RO and a slot type associated with an PO. The access procedure component 635 is capable of, configured to, or operable to support a means for transmitting, in accordance with the selected random access configuration, a preamble of the random access message via the RO and a payload of the random access message via the PO.

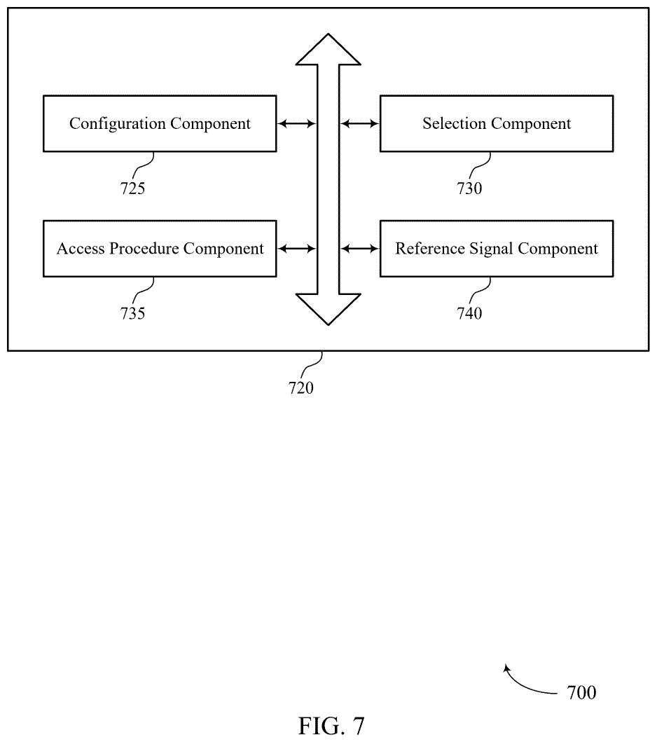

FIG. 7 shows a block diagram 700 of a communications manager 720 that supports dynamic configuration for random access based on slot type in accordance with one or more aspects of the present disclosure. The communications manager 720 may be an example of aspects of a communications manager 520, a communications manager 620, or both, as described herein. The communications manager 720, or various components thereof, may be an example of means for performing various aspects of dynamic configuration for random access based on slot type as described herein. For example, the communications manager 720 may include a configuration component 725, a selection component 730, an access procedure component 735, a reference signal component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration component 725 is capable of, configured to, or operable to support a means for receiving an indication of a first random access configuration and an indication of second random access configuration, where the first random access configuration is associated with channel estimation based on one or more random access preambles, and where the second random access configuration is associated with channel estimation based on one or more DMRSs. The selection component 730 is capable of, configured to, or operable to support a means for selecting, from among the first random access configuration and the second random access configuration, a random access configuration for transmission of a random access message, where selection of the random access configuration is based on a slot type associated with a RO and a slot type associated with an PO. The access procedure component 735 is capable of, configured to, or operable to support a means for transmitting, in accordance with the selected random access configuration, a preamble of the random access message via the RO and a payload of the random access message via the PO.

In some examples, to support selecting the random access configuration for transmitting the random access message, the selection component 730 is capable of, configured to, or operable to support a means for selecting the first random access configuration based on the slot type associated with the RO being a same slot type as the slot type associated with the PO. In some examples, the slot type associated with the RO being the same slot type as the slot type associated with the PO comprises: the RO and the PO both being associated with a UL HD slot type; or the RO and the PO both being associated with a SBFD slot type.

In some examples, to support selecting the random access configuration for transmitting the random access message, the selection component 730 is capable of, configured to, or operable to support a means for selecting the second random access configuration based on the slot type associated with the RO being different than the slot type associated with the PO. In some examples, the slot type associated with the RO being different than the slot type associated with the PO comprises: the RO being associated with a UL slot type and the PO being associated with a SBFD slot type; or the RO being associated with the SBFD slot type and the PO being associated with the UL slot type.

In some examples, the reference signal component 740 is capable of, configured to, or operable to support a means for refraining from transmitting a DMRS via the PO in accordance with the selected random access configuration being the first random access configuration, where the preamble of the random access message supports channel estimation for the PO and decoding of the payload of the random access message.

In some examples, the reference signal component 740 is capable of, configured to, or operable to support a means for transmitting a DMRS via the first PO in accordance with the selected random access configuration being the second random access configuration where the DMRS supports channel estimation for the PO and decoding of the payload of the random access message.

In some examples, the selection component 730 is capable of, configured to, or operable to support a means for selecting, from among the first random access configuration and the second random access configuration, another random access configuration for transmission of a second random access message, where the other random access configuration for transmission of the second random access message is different than the selected random access configuration for transmission of the random access message, and where selection of the other random access configuration is based on a slot type associated with a second RO and a slot type associated with a second PO. In some examples, the access procedure component 735 is capable of, configured to, or operable to support a means for transmitting, in accordance with the other random access configuration, a preamble of the second random access message via the second RO and a payload of the second random access message via the PO.

In some examples, the first random access configuration is associated with a first set of random access preambles and the second random access configuration is associated with a second set of random access preambles, and the selection component 730 is capable of, configured to, or operable to support a means for selecting a preamble for the random access message, where whether the selected preamble is selected from the first set of random access preambles or from the second set of random access preambles is based on the slot type associated with the RO and the slot type associated with the PO, a RSRP threshold, a retransmission counter, or any combination thereof.

In some examples, selection of the random access configuration is further based on whether a separation in time between the RO and the PO satisfies a threshold duration.

In some examples, the first random access configuration, the second random access configuration, or both include an indication of the threshold duration. In some examples, the first random access configuration is eligible for selection when the separation in time between the RO and the PO is less than the threshold duration. In some examples, the first random access configuration is ineligible for selection when the separation in time between the RO and the PO is greater than the threshold duration.

In some examples, the slot type associated with the RO is a HD slot type or a SBFD slot type. In some examples, the slot type associated with the PO is the HD slot type or the SBFD slot type.

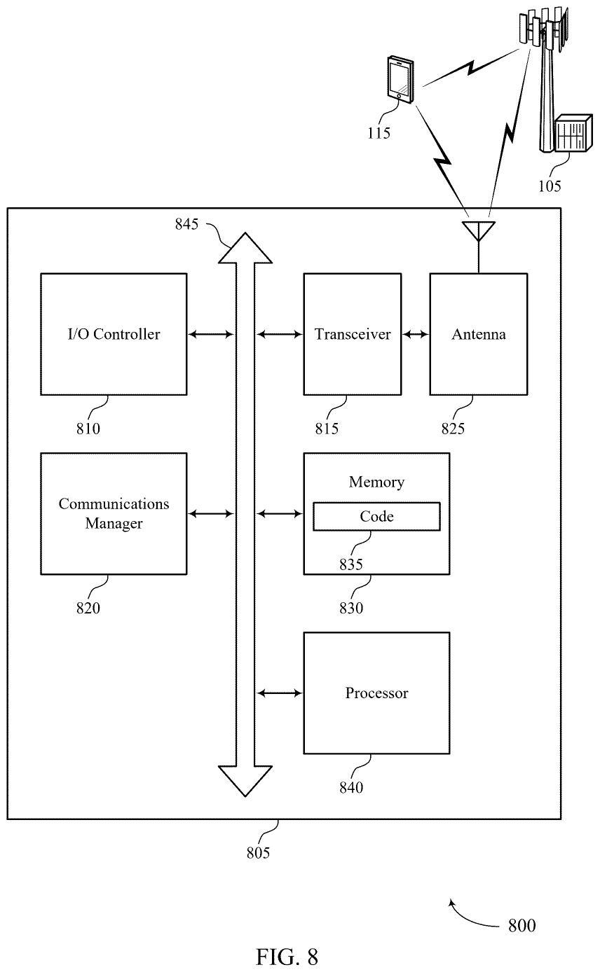

FIG. 8 shows a diagram of a system 800 including a device 805 that supports dynamic configuration for random access based on slot type in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting dynamic configuration for random access based on slot type). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving an indication of a first random access configuration and an indication of second random access configuration, where the first random access configuration is associated with channel estimation based on one or more random access preambles, and where the second random access configuration is associated with channel estimation based on one or more DMRSs. The communications manager 820 is capable of, configured to, or operable to support a means for selecting, from among the first random access configuration and the second random access configuration, a random access configuration for transmission of a random access message, where selection of the random access configuration is based on a slot type associated with a RO and a slot type associated with an PO. The communications manager 820 is capable of, configured to, or operable to support a means for transmitting, in accordance with the selected random access configuration, a preamble of the random access message via the RO and a payload of the random access message via the PO.

By including or configuring the communications manager 820 in accordance with examples as described herein, the device 805 may support techniques for reduced latency and improved user experience related to more efficient utilization of communication resources and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling as described herein via the transceiver 815. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of dynamic configuration for random access based on slot type as described herein, or the at least one processor 840 and the at least one memory 830 may be otherwise configured to, individually or collectively, perform or support such operations.

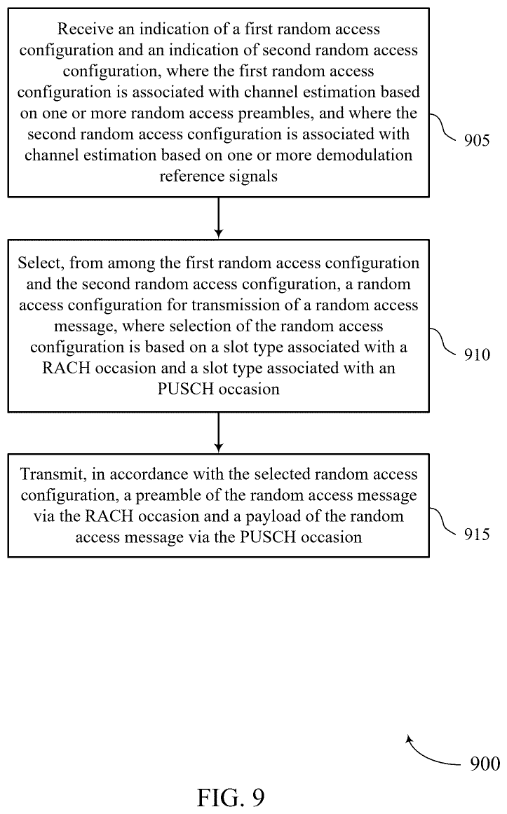

FIG. 9 shows a flowchart illustrating a method 900 that supports dynamic configuration for random access based on slot type in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving an indication of a first random access configuration and an indication of second random access configuration, where the first random access configuration is associated with channel estimation based on one or more random access preambles, and where the second random access configuration is associated with channel estimation based on one or more DMRSs. The operations of 905 may be performed in accordance with examples as disclosed herein. In some examples, aspects of the operations of 905 may be performed by a configuration component 725 as described with reference to FIG. 7. Additionally, or alternatively, means for performing 905 may, but not necessarily, include, for example, one or more antennas 825, transceiver 815, communications manager 820, at least one memory 830, code 835, and at least one processor 840, and/or one or more buses (e.g., a bus 845).

At 910, the method may include selecting, from among the first random access configuration and the second random access configuration, a random access configuration for transmission of a random access message, where selection of the random access configuration is based on a slot type associated with a RO and a slot type associated with an PO. The operations of 910 may be performed in accordance with examples as disclosed herein. In some examples, aspects of the operations of 910 may be performed by a selection component 730 as described with reference to FIG. 7. Additionally, or alternatively, means for performing 905 may, but not necessarily, include, for example, I/O controller 810, communications manager 820, at least one memory 830, code 835, and at least one processor 840, and/or one or more buses (e.g., a bus 845).

At 915, the method may include transmitting, in accordance with the selected random access configuration, a preamble of the random access message via the RO and a payload of the random access message via the PO. The operations of 915 may be performed in accordance with examples as disclosed herein. In some examples, aspects of the operations of 915 may be performed by an access procedure component 735 as described with reference to FIG. 7. Additionally, or alternatively, means for performing 905 may, but not necessarily, include, for example, one or more antennas 825, transceiver 815, communications manager 820, at least one memory 830, code 835, and at least one processor 840, and/or one or more buses (e.g., a bus 845).

The following provides an overview of aspects of the present disclosure:

Aspect 1: A method for wireless communications at a UE, comprising: receiving an indication of a first random access configuration and an indication of second random access configuration, wherein the first random access configuration is associated with channel estimation based at least in part on one or more random access preambles, and wherein the second random access configuration is associated with channel estimation based at least in part on one or more DMRSs; selecting, from among the first random access configuration and the second random access configuration, a random access configuration for transmission of a random access message, wherein selection of the random access configuration is based at least in part on a slot type associated with a RO and a slot type associated with an PO; and transmitting, in accordance with the selected random access configuration, a preamble of the random access message via the RO and a payload of the random access message via the PO.

Aspect 2: The method of aspect 1, wherein selecting the random access configuration for transmitting the random access message comprises: selecting the first random access configuration based at least in part on the slot type associated with the RO being a same slot type as the slot type associated with the PO.

Aspect 3: The method of aspect 2, wherein the slot type associated with the RO being the same slot type as the slot type associated with the PO comprises: the RO and the PO both being associated with a UL HD slot type; or the RO and the PO both being associated with a SBFD slot type.

Aspect 4: The method of any of aspects 1 through 3, wherein selecting the random access configuration for transmitting the random access message comprises: selecting the second random access configuration based at least in part on the slot type associated with the RO being different than the slot type associated with the PO.

Aspect 5: The method of aspect 4, wherein the slot type associated with the RO being different than the slot type associated with the PO comprises: the RO being associated with a UL slot type and the PO being associated with a SBFD slot type; or the RO being associated with the SBFD slot type and the PO being associated with the UL slot type.

Aspect 6: The method of any of aspects 1 through 5, further comprising: refraining from transmitting a DMRS via the PO in accordance with the selected random access configuration being the first random access configuration, wherein the preamble of the random access message supports channel estimation for the PO and decoding of the payload of the random access message.

Aspect 7: The method of any of aspects 1 through 6, further comprising: transmitting a DMRS via the first PO in accordance with the selected random access configuration being the second random access configuration wherein the DMRS supports channel estimation for the PO and decoding of the payload of the random access message.

Aspect 8: The method of any of aspects 1 through 7, further comprising: selecting, from among the first random access configuration and the second random access configuration, another random access configuration for transmission of a second random access message, wherein the other random access configuration for transmission of the second random access message is different than the selected random access configuration for transmission of the random access message, and wherein selection of the other random access configuration is based at least in part on a slot type associated with a second RO and a slot type associated with a second PO; and transmitting, in accordance with the other random access configuration, a preamble of the second random access message via the second RO and a payload of the second random access message via the PO.

Aspect 9: The method of any of aspects 1 through 8, wherein the first random access configuration is associated with a first set of random access preambles and the second random access configuration is associated with a second set of random access preambles, the method further comprising: selecting a preamble for the random access message, wherein whether the selected preamble is selected from the first set of random access preambles or from the second set of random access preambles is based at least in part on the slot type associated with the RO and the slot type associated with the PO, a RSRP threshold, a retransmission counter, or any combination thereof.

Aspect 10: The method of any of aspects 1 through 9, wherein selection of the random access configuration is further based at least in part on whether a separation in time between the RO and the PO satisfies a threshold duration.

Aspect 11: The method of aspect 10, wherein the first random access configuration, the second random access configuration, or both comprise an indication of the threshold duration; the first random access configuration is eligible for selection when the separation in time between the RO and the PO is less than the threshold duration; and the first random access configuration is ineligible for selection when the separation in time between the RO and the PO is greater than the threshold duration.

Aspect 12: The method of any of aspects 1 through 11, wherein the slot type associated with the RO is a HD slot type or a SBFD slot type, and the slot type associated with the PO is the HD slot type or the SBFD slot type.

Aspect 13: A UE for wireless communications, comprising one or more memories storing processor-executable code, a transceiver, and one or more processors coupled with the one or more memories and the transceiver, the one or more processors individually or collectively configured to (e.g., operable to execute the code to) cause the UE to perform a method of any of aspects 1 through 12.

Aspect 14: A UE for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver, the one or more processors configured to cause the UE to:
receive, via the transceiver, an indication of a first random access configuration and an indication of second random access configuration, wherein the first random access configuration is associated with channel estimation based at least in part on one or more random access preambles, and wherein the second random access configuration is associated with channel estimation based at least in part on one or more demodulation reference signals;
select, from among the first random access configuration and the second random access configuration, a random access configuration for transmission of a random access message, wherein selection of the random access configuration is based at least in part on a slot type associated with a random access channel (RACH) occasion and a slot type associated with a physical uplink shared channel (PUSCH) occasion; and
transmit, via the transceiver, in accordance with the selected random access configuration, a preamble of the random access message via the RACH occasion and a payload of the random access message via the PUSCH occasion.

2. The UE of claim 1, wherein, to select the random access configuration for transmitting the random access message, the one or more processors are configured to cause the UE to:
select the first random access configuration based at least in part on the slot type associated with the RACH occasion being a same slot type as the slot type associated with the PUSCH occasion.

3. The UE of claim 2, wherein the slot type associated with the RACH occasion being the same slot type as the slot type associated with the PUSCH occasion comprises:
the RACH occasion and the PUSCH occasion both being associated with an uplink half-duplex slot type; or
the RACH occasion and the PUSCH occasion both being associated with a subband full-duplex (SBFD) slot type.

4. The UE of claim 1, wherein, to select the random access configuration for transmitting the random access message, the one or more processors are configured to cause the UE to:
select the second random access configuration based at least in part on the slot type associated with the RACH occasion being different than the slot type associated with the PUSCH occasion.

5. The UE of claim 4, wherein the slot type associated with the RACH occasion being different than the slot type associated with the PUSCH occasion comprises:
the RACH occasion being associated with an uplink slot type and the PUSCH occasion being associated with a subband full-duplex (SBFD) slot type; or
the RACH occasion being associated with the SBFD slot type and the PUSCH occasion being associated with the uplink slot type.

6. The UE of claim 1, wherein the one or more processors are further configured to cause the UE to:
refrain from transmitting a demodulation reference signal via the PUSCH occasion in accordance with the selected random access configuration being the first random access configuration, wherein the preamble of the random access message supports channel estimation for the PUSCH occasion and decoding of the payload of the random access message.

7. The UE of claim 1, wherein the one or more processors are further configured to cause the UE to:
transmit, via the transceiver, a demodulation reference signal via the first PUSCH occasion in accordance with the selected random access configuration being the second random access configuration wherein the demodulation reference signal supports channel estimation for the PUSCH occasion and decoding of the payload of the random access message.

8. The UE of claim 1, wherein the one or more processors are further configured to cause the UE to:
select, from among the first random access configuration and the second random access configuration, another random access configuration for transmission of a second random access message, wherein the other random access configuration for transmission of the second random access message is different than the selected random access configuration for transmission of the random access message, and wherein selection of the other random access configuration is based at least in part on a slot type associated with a second RACH occasion and a slot type associated with a second PUSCH occasion; and
transmit, via the transceiver, in accordance with the other random access configuration, a preamble of the second random access message via the second RACH occasion and a payload of the second random access message via the PUSCH occasion.

9. The UE of claim 1, wherein the first random access configuration is associated with a first set of random access preambles and the second random access configuration is associated with a second set of random access preambles, and wherein the one or more processors are further configured to cause the UE to:
select a preamble for the random access message, wherein whether the selected preamble is selected from the first set of random access preambles or from the second set of random access preambles is based at least in part on the slot type associated with the RACH occasion and the slot type associated with the PUSCH occasion, a reference signal received power threshold, a retransmission counter, or any combination thereof.

10. The UE of claim 1, wherein the one or more processors are configured to cause the UE to select the random access configuration further based at least in part on whether a separation in time between the RACH occasion and the PUSCH occasion satisfies a threshold duration.

11. The UE of claim 10, wherein:
the first random access configuration, the second random access configuration, or both comprise an indication of the threshold duration;
the first random access configuration is eligible for selection when the separation in time between the RACH occasion and the PUSCH occasion is less than the threshold duration; and
the first random access configuration is ineligible for selection when the separation in time between the RACH occasion and the PUSCH occasion is greater than the threshold duration.

12. The UE of claim 1, wherein:
the slot type associated with the RACH occasion is a half-duplex slot type or a subband full-duplex (SBFD) slot type, and
the slot type associated with the PUSCH occasion is the half-duplex slot type or the SBFD slot type.

13. A method for wireless communications at a user equipment (UE), comprising:
receiving an indication of a first random access configuration and an indication of second random access configuration, wherein the first random access configuration is associated with channel estimation based at least in part on one or more random access preambles, and wherein the second random access configuration is associated with channel estimation based at least in part on one or more demodulation reference signals;
selecting, from among the first random access configuration and the second random access configuration, a random access configuration for transmission of a random access message, wherein selection of the random access configuration is based at least in part on a slot type associated with a random access channel (RACH) occasion and a slot type associated with a physical uplink shared channel (PUSCH) occasion; and
transmitting, in accordance with the selected random access configuration, a preamble of the random access message via the RACH occasion and a payload of the random access message via the PUSCH occasion.

14. The method of claim 13, wherein selecting the random access configuration for transmitting the random access message comprises:
selecting the first random access configuration based at least in part on the slot type associated with the RACH occasion being a same slot type as the slot type associated with the PUSCH occasion.

15. The method of claim 13, wherein selecting the random access configuration for transmitting the random access message comprises:
selecting the second random access configuration based at least in part on the slot type associated with the RACH occasion being different than the slot type associated with the PUSCH occasion.

16. The method of claim 13, further comprising:
refraining from transmitting a demodulation reference signal via the PUSCH occasion in accordance with the selected random access configuration being the first random access configuration, wherein the preamble of the random access message supports channel estimation for the PUSCH occasion and decoding of the payload of the random access message.

17. The method of claim 13, further comprising:
transmitting a demodulation reference signal via the first PUSCH occasion in accordance with the selected random access configuration being the second random access configuration wherein the demodulation reference signal supports channel estimation for the PUSCH occasion and decoding of the payload of the random access message.

18. The method of claim 13, further comprising:
selecting, from among the first random access configuration and the second random access configuration, another random access configuration for transmission of a second random access message, wherein the other random access configuration for transmission of the second random access message is different than the selected random access configuration for transmission of the random access message, and wherein selection of the other random access configuration is based at least in part on a slot type associated with a second RACH occasion and a slot type associated with a second PUSCH occasion; and
transmitting, in accordance with the other random access configuration, a preamble of the second random access message via the second RACH occasion and a payload of the second random access message via the PUSCH occasion.

19. The method of claim 13, wherein the first random access configuration is associated with a first set of random access preambles and the second random access configuration is associated with a second set of random access preambles, the method further comprising:
selecting a preamble for the random access message, wherein whether the selected preamble is selected from the first set of random access preambles or from the second set of random access preambles is based at least in part on the slot type associated with the RACH occasion and the slot type associated with the PUSCH occasion, a reference signal received power threshold, a retransmission counter, or any combination thereof.

20. A non-transitory computer-readable medium storing code for wireless communications, the code comprising instructions executable by one or more processors to:
receive an indication of a first random access configuration and an indication of second random access configuration, wherein the first random access configuration is associated with channel estimation based at least in part on one or more random access preambles, and wherein the second random access configuration is associated with channel estimation based at least in part on one or more demodulation reference signals;
select, from among the first random access configuration and the second random access configuration, a random access configuration for transmission of a random access message, wherein selection of the random access configuration is based at least in part on a slot type associated with a random access channel (RACH) occasion and a slot type associated with a physical uplink shared channel (PUSCH) occasion; and
transmit, in accordance with the selected random access configuration, a preamble of the random access message via the RACH occasion and a payload of the random access message via the PUSCH occasion.
